(19) United States
(12) Patent Application Publication
(10) Pub. No.: US 2010/0085739 A1
(43) Pub. Date: Apr. 8, 2010

(54) FLASHLIGHT WITH FOLDING KNIFE

(75) Inventors: Darin M. Webb, Wichita, KS (US); Derrick S. Lentz, Wichita, KS (US)

Correspondence Address: The Coleman Company, 3600 North Hydraullic, IP Legal- 11702, WICHITA, KS, 67219, US

(73) Assignee: THE COLEMAN COMPANY, INC., Wichita, KS (US)

(21) Appl. No.: 12/515,939

(22) PCT Filed: Aug. 28, 2007
(86) PCT No.: PCT/US07/76952

§ 371 Date: Dec. 2, 2009

Related U.S. Application Data
(60) Provisional application No. 60/866,778, filed on Nov. 21, 2006.

(51) Int. Cl. F21L 4/00; B26B 3/06

(52) U.S. Cl. 362/157; 30/155; 362/253

(57) ABSTRACT

A flashlight with a folding knife. When opened, the knife extends out of the light end of the flashlight. When closed, the knife is centered between two sets of batteries, providing balance for the flashlight. The flashlight is put in the open configuration from the closed configuration by rotating the knife about an axis.

### BACKGROUND OF THE INVENTION

In general, a flashlight is a portable electric light, such as a luminaire configured to be held by a user. Flashlights are useful for a variety of different applications, including use for light in the outdoors, backup lighting in a power outage, or as a source of light to find an object in a dark location.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description of some embodiments that are presented later.

In accordance with an embodiment, a flashlight is provided. The flashlight includes a blade. The blade includes a pivot for folding the blade from a closed configuration to an open configuration.

In an embodiment, when opened, the knife extends out of the light end of the flashlight. A cutout may be provided in the knife so that moving the knife to the opened position results in at least a portion of the knife being positioned in the light beam directly in front of the flashlight. In accordance with another embodiment, when closed, the knife is centered between two sets of batteries, providing balance for the flashlight. The flashlight is put in the open configuration from the closed configuration by rotating the knife about an axis.

Other features of the invention will become apparent from the following detailed description when taken in conjunction with the drawings, in which:

### BRIEF DESCRIPTION OF THE DRAWINGS

FIG. 1 is a side perspective view of a flashlight with a knife in a closed configuration, in accordance with an embodiment.

FIG. 2 is a side perspective view of the flashlight of FIG. 1, with the knife in an open configuration.

FIG. 3 is a side view of the flashlight of FIG. 1, with the knife in an open configuration.

FIG. 4 is an exploded side perspective view of the flashlight of FIG. 1, in accordance with an embodiment.

FIG. 5 is a representation of a circuit diagram for the flashlight of FIG. 1, in accordance with an embodiment.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

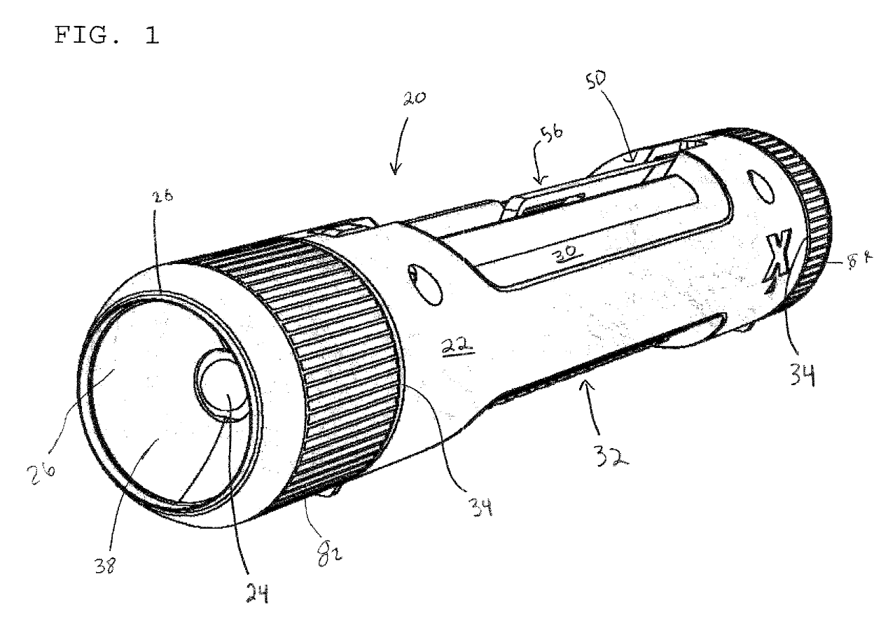

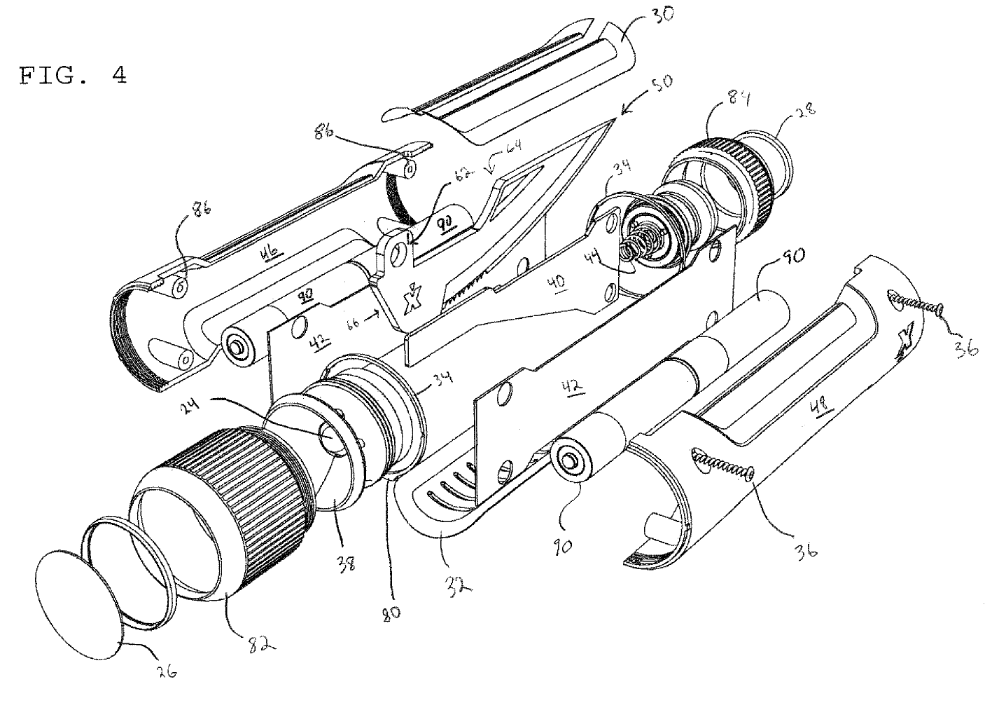

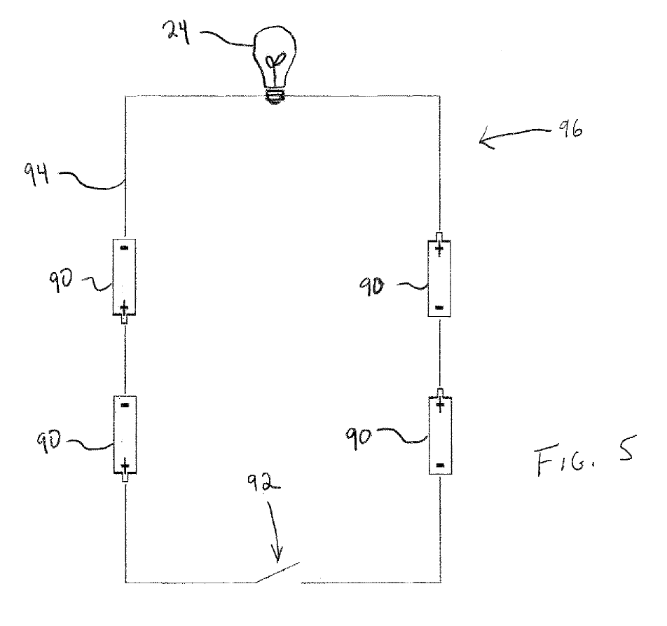

Referring now to the drawings, in which like reference numerals represent like parts throughout the several views, FIG. 1 shows a flashlight 20 in accordance with an embodiment. The flashlight 20 is designed for use with batteries although other power sources may be used. As shown in FIG. 4, the flashlight 20 includes a lens 26, a reflector 38, and a lamp 24.

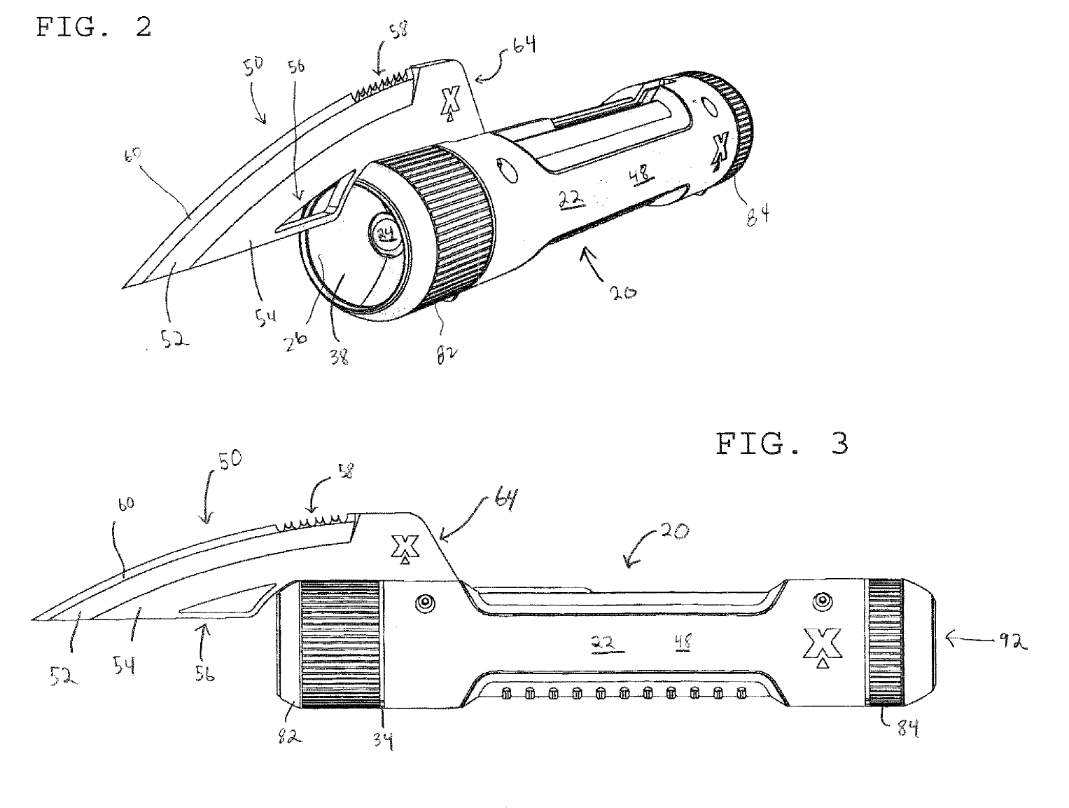

In accordance with an embodiment, the flashlight 20 includes a main body 22 and a knife 50. In a first configuration, shown in FIG. 1, the knife 50 is in a closed or storage configuration wherein it is substantially inside the main body 22 of the flashlight 20. As shown in FIG. 2, the flashlight 20 may be put into an open configuration wherein the knife 50 is exposed and extends out of a top end (i.e., a light end) of the flashlight.

In accordance with an embodiment, as shown in FIG. 4, the main body 22 includes a top bezel 82, a bottom bezel 84, a first side portion 46, and a second side portion 48. In an embodiment, the top bezel 82, bottom bezel 84, first side portion 46, and second side portion 48 are made of metal and configured so that, when placed together, they form a shape similar to a cylinder. Other materials, such as, plastic, may be used. Also, the main body 22 may be formed in other shapes such as prisms with square or other cross sections, or shapes having a varying cross section. The top bezel 82, and side portions 46, 48 may be configured with threads to allow a user to unscrew the top bezel 82 to access parts inside the flashlight 20, some of which are described below. The bottom bezel 84 may also thread onto the side portions 46, 48. The main body 22 may also be configured in other configurations, such as from a unitary piece of material, or may have more or fewer pieces.

In accordance with an embodiment, the knife 50 includes a blade 52 and a body 54 (e.g., FIG. 2). As shown in FIG. 3, the blade 52 may be shaped like a crescent and include a serrated cutting edge 58 and a smooth cutting edge 60. The body 54 may include a pivot hole 62 (FIG. 4), a back edge 64, a rear edge 66, and a notch 56. As shown in FIG. 3, the blade 52 and the body 54 may be configured from a single unit, for example a piece of stainless steel. The body 54, or any part of the knife 50, may be anodized.

In accordance with an embodiment, as shown in FIG. 4, the flashlight 20 includes side plates 42 and a locking plate 40. In the embodiment shown in the drawings, the side plates 42 extend parallel to and are captured between the first and second side portions 46, 48. The side plates 42 are spaced from one another. When the flashlight 20 is in a closed configuration, the knife 50 and the locking plate 40 extend parallel to and are captured between the side plates 42. The side plates 42 and the locking plate 40 may include holes through which screws may run, aligning the side plates 42 and locking plate 40 in a suitable position. For example, as shown in FIG. 4, a screw 36 runs through holes in the second side portion 48, through a side plate 42, through the pivot hole 62 of the knife 50, through a hole in the other side plate 42 and into a screw receiver 86 in the first side portion 46. Also, a screw 36 runs through a hole in the second side portion 48 through a hole in one of the side plates 42, through a hole in the locking plate 40, through a hole in another side plate 42, and then to a screw receiver 86 in the first side portion 46. Attaching the side portions 46, 48 in this manner allows for the parts inside the main body 22 of the flashlight 20 to be property aligned. However, other means of aligning the parts of the flashlight 20 may be used.

The locking plate 40 is configured so that a user may grasp the knife 50 at a first closed configuration, as shown in FIG. 1, so that the knife may be moved to a second open configuration, shown in FIG. 2. As shown in FIG. 1, when the knife 20 is in the closed configuration, at least part of the notch 56 protrudes out of the main body 22 of the flashlight 20. A user may grip the notch 56 with his or her fingers and pull the knife 50 in a direction away from the main body 22 of the flashlight 20 so as to rotate the knife 50 about the pivot hole 62 of the knife 50 until the knife 50 is in an open configuration. When the knife 50 is in the open configuration, the locking plate 40 rests against the rear edge 66 of the knife 50 in a manner known in the locking knife art, thereby locking the knife 50 in place.

As can be seen in FIG. 3, the knife 50 may be configured so that when the knife 50 is in the open configuration, a portion of the knife 50 extends in front of the reflector 38, and thus the portion is positioned in a beam of the flashlight 20. Specifically, the knife 50 is configured so that there is a substantial cutout between the pivot hole 62 and the notch 56. This cutout extends around and captures a portion of the front or top bezel 82 of the flashlight 20 when the knife 50 is in the opened position. This feature permits at least a portion of the knife 50 to be within the light beam directly in front of the flashlight 20, thus aligning the knife more with the area illuminated by the flashlight.

In accordance with an embodiment, the user may move the knife 50 from an open configuration to a closed configuration by pressing down on the locking plate 40 and rotating the knife about the pivot hole 62. Pushing down on the locking plate 40 moves the locking plate 40 away from the rear edge 66 of the knife 50 and frees the knife 50 for movement.

While the drawings show one particular embodiment for providing a flashlight with a folding knife, other embodiments are within the spirit of the invention. For instance, other mechanisms for locking the knife blade in place may be used, such as those found in folding knives.

In accordance with an embodiment, the flashlight 20 includes four batteries 90. As shown in FIG. 4, the knife 50 rests between two sets of two batteries 90 when the flashlight 20 is in the closed position. Other configurations may have all the batteries on one side of the knife 50, or may have one number of batteries on one side of the knife 50 and another number on the other side. As shown in FIG. 5, the batteries 90 are connected to the circuit 96 in series and are connected to the circuit by a wire 94. Other configurations may also be used. For example, the flashlight 20 may include parts other than wires that can conduct electricity. Also, one or more sets of batteries may be connected to the circuit in parallel. FIG. 4 shows the flashlight 20 having four batteries, but other numbers of batteries may also be used. Indeed, any power source suitable for powering a flashlight may be used, including, but not limited to, rechargeable batteries.

The arrangement of the batteries 90 shown in the drawings is particularly advantageous in that the arrangement permits room for a deep knife blade, such as the knife 50. That is, the batteries 90 extend down opposite sides of the flashlight 20, and permit the closed knife 50 to be captured between the batteries and to extend almost to the other side of the flashlight without interference by the batteries. In the shown embodiment, the flashlight is kept smaller by utilizing smaller batteries, such as AA dry cell batteries, along the outside of the flashlight 20.

Dividing the batteries 90 between opposite sides of the flashlight 20 provides better balance of the weight of the flashlight. By arranging two batteries 90 on each side of the knife 50, the weight of the flashlight is more evenly distributed when the knife is extended. Arranging the batteries 90 on opposite sides also allows the knife to be centered in the flashlight 20, providing more comfort when the knife 50 is closed or extended.

The flashlight 20 may also include other features. As shown in FIG. 4, the flashlight 20 may include rings 34 that connect between the main body 22 and the top and bottom bezels 82, 84. It may also include a top overmold 30 and a bottom overmold 32. The rings 34 may be configured with a flat portion 80 so that when the flashlight 20 is placed on a surface, the flat portion 80 will prevent the flashlight 20 from rolling more than a short distance. A flashlight may also have one ring or more than two rings or no rings at all. The lamp 24 may be a light emitting diode (LED) or other means of lighting may be used, such as incandescent or halogen lamps or other light sources. In addition, while the drawings show the flashlight 20 having only one lamp, a flashlight may include more than one lamp, such as an array of LEDs. One or more of the overmolds 30, 32 may be made of rubber, or other material, so as to provide a grip for the flashlight 20. Overmolds 30, 32 are advantageous in that they provide a grip for using the knife 50.

As shown FIG. 3, when the flashlight 20 is in the open configuration, the knife 50 points out of and beyond the end of the flashlight having a lamp 24. The flashlight 20 may also be configured so that the knife 50 points out of the opposite end of the flashlight 20 when in the open configuration. However, having the knife 50 point out of the end with the lamp 24 provides several advantages. For example, in the configuration shown in the drawings, when the knife 50 is in the open configuration, the flashlight 20 may illumine objects being cut by the knife and surrounding objects. This feature is enhanced by the cutout in the knife 50 that permits a portion of the knife to extend into the light beam, as described above. In addition, a user using the flashlight 20 to illumine something with the flashlight 20 in the open configuration is less likely to injure himself, for instance, by stabbing himself if the user inadvertently trips.

Even though the drawings show the flashlight 20 having one knife 50, a flashlight may include more than one knife and may include other tools and features that are able to fold out of the main body similar to the way the knife 50 folds out of the main body 22. For example, a flashlight may include a screwdriver tool, a bottle opener, a saw, one or more knives varying in size and shape, and other tools. Additional knives and tools may fold out of the main body of a flashlight in various directions. For instance, one set of tools may fold out in one direction, while another set of tools may fold out in the same direction from another portion of the flashlight. In addition, another set of tools may also fold out from the same or different side of the flashlight, but in an opposite direction.

As shown in FIG. 3, the flashlight 20 includes a switch 92 on the end of the flashlight 20 opposite the lamp 24. The switch 92 may also be in other locations. For example, the switch 92 may be on the first side portion 46 or the second side portion 48, or in a position between those portions, or in any position on the flashlight. In addition, other configurations may be used. For instance, a switch may be incorporated into the bottom bezel 84 so that a user may close the circuit 96 to provide power to the lamp 24 by rotating the bottom bezel 84. The top bezel 82, and in general, any part may be similarly configured.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A flashlight, comprising:
a head;
a main body extending from the head and having an exterior and an interior;
a light source for projecting a light pattern from the head; and
a knife attached to the main body and configured to rotate about a pivot between a first position, wherein a cutting edge of the knife is oriented toward the interior of the main body, and a second position, wherein the knife extends past the head and the cutting edge is exposed.

2. The flashlight of claim 1, wherein a portion of the knife extends into the light pattern when the knife is in the second position.

3. The flashlight of claim 2, wherein the knife includes a cutout opposite the cutting edge, the cutout configured to receive a portion of the head when the knife is in the second position.

4. The flashlight of claim 1, wherein the knife includes a cutout opposite the cutting edge, the cutout configured to receive a portion of the head when the knife is in the second position.

5. The flashlight of claim 1, further comprising two rows of batteries, each row having at least one battery in the interior of the main body, the two rows and the knife being arranged such that, when the knife is in the first position, a portion of the cutting edge of the knife extends between the two rows.

6. The flashlight of claim 1, further comprising a structure extending from the main body so as to prevent the flashlight from rolling about the main body.

7. The flashlight of claim 1, wherein at least a portion of the cutting edge is oriented away from a central axis of the light pattern when the knife is in the second position.

8. The flashlight of claim 1, wherein at least a portion of the cutting edge is oriented towards a central axis of the light pattern when the knife is in the second position.

9. The flashlight of claim 1, wherein the pivot is located at or near a juncture between the head and main body.

10. A flashlight, comprising:
a head;
an elongate body extending from the head, configured to be grasped by a hand, and having an exterior and an interior;
a light source for projecting a light pattern from the head;
a portable power source in the interior of the main body and electrically connected to the light source; and
a knife attached to the elongate body and configured to rotate about a pivot between a first position, wherein a cutting edge of the knife is oriented toward the interior of the elongate body, and a second position, wherein the knife extends past the head and the cutting edge is exposed.

11. The flashlight of claim 10, wherein a portion of the knife extends into the light pattern when the knife is in the second position.

12. The flashlight of claim 11, wherein the knife includes a cutout opposite the cutting edge, the cutout configured to receive a portion of the head when the knife is in the second position.

13. The flashlight of claim 10, wherein the knife includes a cutout opposite the cutting edge, the cutout configured to receive a portion of the head when the knife is in the second position.

14. The flashlight of claim 10, wherein the portable power source includes two rows of batteries, each row having at least one battery in the interior of the elongate body, the two rows and the knife being arranged such that, when the knife is in the first position, a portion of the cutting edge of the knife extends between the two rows.

15. The flashlight of claim 10, further comprising a structure extending from the elongate body so as to prevent the flashlight from rolling about the main body.

16. The flashlight of claim 10, wherein at least a portion of the cutting edge is oriented away from a central axis of the light pattern when the knife is in the second position.

17. The flashlight of claim 10, wherein at least a portion of the cutting edge is oriented towards a central axis of the light pattern when the knife is in the second position.

18. The flashlight of claim 10, wherein the pivot is located at or near a juncture between the head and elongate body.
